(19) United States
(12) Patent Application Publication
(10) Pub. No.: US 2025/0010542 A1
(43) Pub. Date: Jan. 9, 2025

(54) VAT POLYMERIZATION PROCESS

(71) Applicant: POLYFOS 3D LTD, Jerusalem (IL)

(72) Inventors: Omri RULF, Jerusalem (IL); Isabell Sarah KARMEL, London (GB); Shlomo MAGDASSI, Jerusalem (IL)

(21) Appl. No.: 18/708,749

(22) PCT Filed: Nov. 10, 2022
(86) PCT No.: PCT/IL2022/051199

§ 371 Date: May 9, 2024

Related U.S. Application Data
(60) Provisional application No. 63/263,989, filed on Nov. 12, 2021.

(51) Int. Cl. B29C 64/135; B29C 64/277; B33Y 10/00

(52) U.S. Cl. CPC B29C 64/135; B29C 64/277; B33Y 10/00; B29K 2995/0021

(57) ABSTRACT

A vat photopolymerization process comprises irradiating a resin comprising two or more different types of polymerizable materials and two or more different types of light-sensitive materials, at least two of said two or more light-sensitive materials are selected from radical and ionic initiators, wherein each of the two or more different types of polymerizable materials is polymerized into a different polymeric material by a different initiator of the at least two initiators, wherein one or more of the two or more different types of polymerizable materials is polymerized into one or more soluble polymeric materials that are each partially or fully soluble in a fluid selected from a solvent and a solution, said fluid not present in the resin and in which each of the other polymeric materials are insoluble; wherein said irradiating comprising directing a multiwavelength device or a plurality of light sources generating radiation of different wavelengths in a direction of the resin to initiate or induce selective polymerization of each of the two or more different types of polymerizable materials in different regions of the resin to yield the 3D object; and treating the object in the fluid to cause dissolution of the one or more soluble polymeric materials in the solvent or the solution, maintaining intact each of the other polymeric materials present in the object.

### FIELD OF THE INVENTION

The invention generally relates to novel vat photopolymerization processes.

### BACKGROUND OF THE INVENTION

3-Dimensional (3D) printing, or additive manufacturing, is the construction of a three-dimensional object from a computer-aided design (CAD) file. Vat photopolymerization is a form of 3D printing technology that takes advantage of photopolymerization processes, to solidify a photo-reactive resin and build the 3-dimensional object, using materials from a resin tank (vat) containing polymerizable compositions.

A vat photopolymerization (VPP) 3D printer is composed of a stage, a resin vat, and a light source. The 3D printing process can be a ‘bottom-up’ process wherein a light source is located below the photocurable resin tank and separated by a film or layer from the photocurable material or a ‘top-down’ process with the light source being located above the photopolymer vat, without a film or separation layer between the light source and the tank. In both approaches, the 3D object is formed on a platform that is provided in a resin tank; and which is capable of moving downward in the tank for top-down applications.

Vat photopolymerization additive manufacturing is popular due to its high precision, high resolution, and high-speed throughput. As support structures are needed for printing overhanging parts of the object, as well as thin wall thicknesses which are vital for obtaining intricate geometries, often designed specifically for 3D printing, manufacturing is not trivial. To increase the throughput in VPP, parts are 3D printed in ‘vertical stacks’, with supports provided between the single parts. Currently, VPP methods are limited to the use of one material formulations, such that both the support elements and the the actual parts are formed of the same material. As the support structures must be removed to release the parts after the 3D printing process is completed, chemical dissolution methods cannot be used. Instead, separation between the support elements and the parts manufactured is achieved manually. The time and labour-intensive process involved is often followed by a polishing step required for achieving high-quality surface finishes for many applications, mainly in the medical, dental, and aerospace sectors. The inefficiency of manufacturing with supports, especially when using vertical stacks, significantly reduces the overall efficiency of the 3D printing process and often prevents users from using VPP for production purposes.

Research carried out by Boydston et al [1] found that use of two distinct wavelengths of light can be used to control two different polymerization mechanisms. This paper describes use of a 3D printer with two DLP projectors that illuminate the resin mixture with UV light (365 nm) and visible light (460 nm). The researchers were able to obtain 3D-printed parts with hard and soft domains by controlling the wavelength used. Furthermore, parts were fabricated containing water-swellable, as well as non-swellable segments. The resin vat contained two types of monomer mixtures with two different photoinitiators. Each type of monomer mixture was capable of polymerization by a different polymerization mechanism or initiation, yielding parts with two different mechanical properties.

Recent years have shown significant development in multi-material 3D printing, solvent-soluble supports, and multi-colored parts. However, most of these examples focus on using Fused Filament Fabrication (FFF) or jetting techniques. The following citations provide an overview of recent progress in multi-material 3D printing and soluble supports:

International Patent Publication No. WO 2018/057330 [2] discloses a method of making a 3-dimensional article, using two or more types of polymerizable monomers and two or more types of polymerization initiators, wherein the composition comprises a build region: wherein each type of polymerizable monomer is configured to be polymerizable using a respective type of polymerization initiator of the two or more types, and each respective type of polymerization initiator cannot polymerize a different type of polymerizable monomer of the two or more types; The 3-dimensional object is built in a layer-by-layer fashion on a built platform that moves away from the photopolymer vat.

The compositions and methods only disclose the fabrication of objects with two different mechanical properties: hard and soft domains, as well as the fabrication of parts with segments that swell in water and segments that do not display a swelling behaviour, but do not include methods for multi-material 3D printing wherein one of the polymers formed is soluble in a solvent. Moreover, it does not disclose the multi-color three-dimensional vat photopolymerization.

LS Patent Application No. 2020/0282638 [3] relates to the method of fabricating a 3-dimensional object using electromagnetic radiation emitted from a visual display screen (LCD) or emissive pixel array screen illuminated by radiation sources with effectively non-overlapping wavelength emission spectra with the effect of creating two different polymerized properties in the object. This invention specifically requires the use of an LCD screen for the fabrication of the object. Furthermore, the compositions and methods disclosed do not include methods for multi-materials wherein one of the polymers formed is soluble in a solvent. Moreover, it does not disclose the multi-color three-dimensional vat photopolymerization.

U.S. Pat. No. 10,113,064 [4] discloses a material composition, which may be used as a support material, for three-dimensional (3D) inkjet printing. The material composition disclosed is based on polyethylene glycol and dimethylhexane diol, which is soluble in water. However, unlike vat polymerization, inkjet printing involves different printheads that can jet different materials at the same or adjacent layers and therefore enables the fabrication of objects composed of several materials, making it a complex system. Additionally, the materials used in this process have an inherent viscosity limitation, limiting the scope of materials that can be used.

U.S. Pat. No. 10,675,853 [5] discloses a support material for use in an additive manufacturing system, specifically in Fused Filament Fabrication (FFF) which includes a thermoplastic copolymer polymerized from monomers comprising acid-functional monomers having carboxylic acid groups, and one or more non-acid-functional monomers, where a portion of the carboxylic acid groups are neutralized with a base having an alkali metal cation. The neutralized thermoplastic copolymer is soluble in an alkaline aqueous solution. As this is a thermoplastic material, extruded into a filament, it can only be used in suitable Fused Filament Fabrication systems.

Chinese Patent Application No. 105111380 [6] discloses a support material for inkjet photopolymerization additive manufacturing that has excellent water solubility after light forming and is easy to remove.

Chinese Patent Application No. 101027170 [7] discloses a composition for making a three-dimensional object. The composition comprises a plasticizer and a base polymer, where the base polymer comprises a carboxylic acid group, and the composition is soluble in an alkaline solution. This material can only be used for Fused Filament Fabrication (FFF) additive manufacturing systems.

U.S. Pat. No. 6,228,923 [8] discloses a unique thermoplastic polymer material, i.e., poly(2-ethyl-2-oxazoline), which is used as a polymer layer material as well as a support material in a freeform fabrication process. This material can only be used for Fused Filament Fabrication (FFF) additive manufacturing systems.

International Patent Publication No. WO2000/062994 [9] discloses a process for 3D printing, in which an alkali-soluble thermoplastic material is used in an additive deposition process to form a soluble support structure for a 3-dimensional object under construction. The alkali-soluble thermoplastic material includes a base polymer with carboxylic acid groups and a plasticizer. Following formation, the object is placed in an alkaline bath to dissolve the support structure. This material can only be used for Fused Filament Fabrication (FFF) additive manufacturing systems.

U.S. Pat. No. 7,754,807 [10] discloses a soluble composition for making a 3-dimensional object. The composition comprises a plasticizer and a base polymer, where the base polymer comprises a carboxylic acid, where the composition is soluble in an alkaline solution. This material can only be used for Fused Filament Fabrication (FFF) additive manufacturing systems.

U.S. Pat. No. 8,246,888 [11] discloses a partially melting support material for Fused Filament Fabrication processes. The material feedstock comprises a first copolymer and a polymeric impact modifier, where the first copolymer includes a first monomer unit comprising a carboxyl group and a second monomer unit comprising a phenyl group. This material can only be used for Fused Filament Fabrication (FFF) additive manufacturing systems.

Chinese Patent Application No. 108698330 [12] discloses a soluble material for three-dimensional modeling, which can be used as a material for supporting a three-dimensional object when the three-dimensional object is produced by a hot-melt lamination-type 3D printer, and which contains a thermoplastic resin having a hydrophilic group and an organic salt compound. This material can only be used for Fused Filament Fabrication (FFF) additive manufacturing systems.

International Patent Publication No. WO2020/077127 [13] discloses compositions of a sulfonated water-dispersible thermoplastic copolymer material for the use as a support material in an additive manufacturing process. The polymer is made from a selected thermoplastic copolymer having an acid or an anhydride group; esterifying the acid group of the selected thermoplastic copolymer with a hydroxyl-functionalized sulfonate salt, or amidizing the acid group of the selected thermoplastic copolymer with an amine sulfonate salt, or imidizing the anhydride group of the selected thermoplastic copolymer with an amine sulfonate salt. The esterification, the amidization, or the imidization results in a sulfonated water thermoplastic dispersible copolymer having a glass transition temperature suitable to provide effective support during the additive manufacturing process and wherein the sulfonated water-dispersible thermoplastic copolymer will disperse in tap water in less than 1 hour. This material can only be used for Fused Filament Fabrication (FFF) additive manufacturing systems.

Chinese Patent Application No. 106573434 [14] discloses an object that can be formed in an additive manufacturing process, such as FFF, by providing a substrate having at least one surface that is made of a first material and forming one or more layers of a second material on the surface of the substrate. A Hildebrand solubility parameter of the second material is within about 5% of a Hildebrand solubility parameter of the first material.

This material and method can only be used for Fused Filament Fabrication (FFF) additive manufacturing systems.

European Patent Application No. 1456307 [15] relates to a jettable non-curable support material composition used for 3-dimensional inkjet printing. The material comprises at least one fatty alcohol and at least one abietic rosin ester alcohol, wherein the support material has a melting point between about 50° C. to about 65° C. and a freezing point between about 45° C. to about 55° C. This material can be used for multi-material printing with MultiJet 3D printing in which one of the materials is soluble in water. However, unlike vat polymerization, inkjet printing involves different printheads that can jet different materials at the same or adjacent layers and therefore enables the fabrication of objects composed of several materials.

Japanese Patent Application No. 2010155889 [16] provides a photocurable liquid resin composition that allows for the fabrication of a 3-dimensional object using 3D inkjet printing with a good solubility of the cured product in water. This material has been described as particularly suitable for the formation of water-soluble supports using 3D inkjet printing. However, unlike vat polymerization, inkjet printing involves different printheads that can jet different materials at the same or adjacent layers and therefore enables the fabrication of objects composed of several materials.

International Patent Publication No. WO2017/112689 [17] describes a material composition for the use in Fused Filament Fabrication (FFF) 3D printing to provide objects which are disintegrable in aqueous solutions. The material formulation described herein is particularly relevant for the formation of soluble and disintegrable support structures. The material disclosed comprises a polymer blend including a blend of at least 2 PVP polymers wherein at least one of these polymers has a molecular weight of 40,000 Dalton or more. This material and method can only be used for Fused Filament Fabrication (FFF) additive manufacturing systems.

European Patent No. 3237473 [18] describes a material composition and method for 3D printing objects with support structures, whereby the support structure is water soluble. The 3-dimensional object fabricated with this method comprises at least one material with a soluble hydrophilic elastomer block with a Tg<30° C. and at least one soluble thermoplastic block with a Tg>30° C. with at least one monomer with a carboxylic acid group. This material and method can only be used for Fused Filament Fabrication (FFF) additive manufacturing systems.

European Patent Application No. 3575065 [19] describes a material composition used for the fabrication of 3-dimensional objects with soluble supports using Fused Filament Fabrication. Said compositions contain a salt compound which ensures solubility.

European Patent No. 2961581 [20] discloses a method for the fabrication of casting parts using water-soluble casting molds made using 3D printing.

U.S. Pat. No. 11,220,612 [21] describes a water-soluble polymer composition formed from melt processing a semi-crystalline water-soluble polymer and sugar and can potentially be used for 3D printing water-soluble parts.

U.S. Pat. No. 10,018,937 [22] describes a support material composition for the use in an electrophotography-based additive manufacturing system that is at least partially removable in a solvent.

Chinese Patent No. 107868433 [23] describes a material composition used as support material for wax 3D printing. Said water-soluble material comprises 20-90 parts of polyethylene glycol wax, 5-50 parts of water-soluble tackifier, 0.1-1 part of nucleating agent, and 0.1-0.5 part of antioxidant and is suitable for wax 3D printing.

Chinese Patent Application No. 104629272 [24] discloses an all-soluble non-softening 3D printing material and its composition for use in Fused Filament Fabrication.

Chinese Patent Application No. 106700357 [25] describes a water-soluble 3D printing support material for Fused Filament Fabrication 3D printing and a preparation method thereof.

Japanese Patent Application No. 2019513183 [26] discloses a method and apparatus for the formation of metal and ceramic 3D printed parts. The parts consist of a ‘part body’ which is a ceramic or metal, a support structure, and a sacrificial boundary area coupling the part body with the support structure. The sacrificial boundary consists at least partially of a second ceramic or metal and the support structure can be separated from the body through chemical or electrochemical processes without melting.

Chinese Patent No. 108084342 [27] discloses a material composition for the fabrication of photocurable soluble supports that can be used in 3D printing. The composition consists of the following components: 44-58% of ultraviolet curing monomer, 40-52% of solvent, 0.4 to 2 percent of photoinitiator, 0.1 to 1 percent of polymerization inhibitor, 1-3% of a surfactant. Due to the high percentage of solvent, this material composition is suitable for 3D inkjet, but not for vat photopolymerization.

US Patent Application No. 2022/0119569 [28] describes a material composition for the fabrication of soluble structures using 3D printing. The material composition comprises one or more ionic/salt-containing monomers; one or more monomers capable of forming solvent soluble or solvent degradable polymers.

### PUBLICATIONS

[1] Multimaterial actinic spatial control 3D and 4D printing, Nat. Commun. 2019, 10, 791.
[2] International Patent Publication No. WO 2018/057330.
[3] US Patent Application No. 2020/0282638.
[4] U.S. Pat. No. 10,113,064.
[5] U.S. Pat. No. 10,675,853.
[6] Chinese Patent Application No. 105111380.
[7] Chinese Patent Application No. 101027170.
[8] U.S. Pat. No. 6,228,923.
[9] International Patent Publication No. WO2000/062994.
[10] U.S. Pat. No. 7,754,807.
[11] U.S. Pat. No. 8,246,888.
[12] Chinese Patent Application No. 108698330.
[13] International Patent Publication No. WO2020/077127.
[14] Chinese Patent Application No. 106573434.
[15] European Patent Application No. 1456307.
[16] Japanese Patent Application No. 2010155889.
[17] International Patent Publication No. WO2017/112689.
[18] European Patent No. 3237473.
[19] European Patent Application No. 3575065.
[20] European Patent No. 2961581.
[21] U.S. Pat. No. 11,220,612.
[22] U.S. Pat. No. 10,018,937.
[23] Chinese Patent No. 107868433.
[24] Chinese Patent Application No. 104629272.
[25] Chinese Patent Application NO. 106700357.
[26] Japanese Patent Application No. 2019513183.
[27] Chinese Patent No. 108084342.
[28] US Patent Application No. 2022/0119569.

### SUMMARY OF THE INVENTION

As stated hereinabove, vat polymerization utilizes support structures for printing overhanging parts (or objects), intricate geometries, or for 3D printing of vertically stacked objects. The use of vertical stacks in additive manufacturing is highly desirable, as it allows for a higher throughput of objects at any given time and a higher printing efficiency. The individual objects are vertically connected in a stacked order through support structures that are crucial for achieving a successful print. Both the objects and the support structures are typically formed of the same polymeric material. As the support structures are required only for achieving an effective process and not required in the object in its final ready-to-use form, the mechanical dissociation of the objects from the support structures is time and labor inefficient.

The invention disclosed herein describes a process that, among other implementations, provides a production methodology that facilitates an effective selective chemical or physical dissociation of printed objects from the support structures. These support structures are used in production (manufacturing) processes disclosed herein that may thus be automated and industrialized. Processes of the invention further enable fabrication of polymeric objects or objects of polymeric composites with ceramic, metallic, and sand-based materials having multiple material regions, permitting selective functionalities and visuality.

By proper tailoring of the polymerizable materials, processes of the invention may further be used in fabrication of ceramic, metallic, or sand-based objects having multiple material regions and solubilities. Sintering steps or post-treatment steps may further provide dense ceramic or metallic objects, with one or more different ceramic or metallic materials.

Processes of the invention generally involve irradiating, with a multi-wavelength light source or with a plurality of different light sources (to thereby generate radiation of different wavelengths), a light-sensitive resin. The multi-wavelength light source of different light sources used are configured or selected and operable to generate several or a plurality of distinct wavelengths that each is capable of initiating or activating a different initiator to cause polymerization of a predetermined material. In other words, the light-sensitive resin may comprise a plurality of different types of polymerizable materials and a corresponding plurality of different polymerization initiators (which may be radical and/or ionic initiators), such that each of the plurality of different initiators is reactive under light of a distinct wavelength, generated by the light source(s), to selectively polymerize one of the different types of polymerizable material. The selective polymerization thus provides a multi-material object that is composed of different material regions or polymers, each having a distinct characteristic profile (that is different from a profile of a different material region in the object). This allows for regions of the object to have different predefined profiles, e.g., profiles defining a region solubility, visual (color, texture, etc), mechanical, compositional, as well as other properties. In accordance with the invention, at least one of the material regions is formed of a material that can be solubilized or decomposed by solubilization in a liquid medium. Thus, processes of the invention may further comprise a step of solubilizing said subitizable region to afford the final object.

Thus, according to the first aspect of the invention, there is provided a process for forming a 3D object having a plurality (two or more) of material regions, one or more of the plurality of material regions is soluble (or decomposable or disintegratable) in a fluid (solvent or solution) not capable of solubilizing the other of said plurality of material regions, the process comprising irradiating with a multi-wavelength light source, or a plurality of light sources, generating radiation of different wavelengths, a resin comprising two or more different types of polymerizable materials (namely, each of the different types can be polymerized via a different polymerization mechanism or by employing a different polymerization initiator) and two or more different types of light-sensitive materials, at least one of said two or more light-sensitive materials is a radical and/or an ionic initiator, wherein each of the two or more different types of polymerizable materials is polymerized into a different polymeric material by a different initiator in response to irradiation (or under exposure to) by a light generated from the light source, said light being of a predetermined wavelength (wherein the wavelength is selected in advance to initiate a particular initiator), wherein one or more (not all, in some embodiments one) of the two or more different types of polymerizable materials is selected to polymerize into one or more soluble polymeric materials that are each fully soluble in a fluid (e.g., a solvent or a solution) not present in the resin and in which each of the other polymeric materials are insoluble, thereby forming the object.

In some embodiments, the process comprises treating the object in the fluid to thereby cause partial or full dissolution, decomposition or disintegration of the one or more soluble polymeric materials.

The invention further provides a process for forming a 3D object having a plurality of material regions, one or more of the plurality of material regions is soluble in a fluid (solvent or solution) not capable of solubilizing the other of said plurality of material regions, the process comprising irradiating with a multi-wavelength light source, or a plurality of light sources, generating radiation of different wavelengths, a resin comprising a plurality of polymerizable materials and a plurality of corresponding radical and/or ionic initiators, wherein each of the plurality of different types of polymerizable materials is polymerized into a different polymeric material by a different initiator in response to irradiation by a light of a predetermined wavelength, wherein one or more of the plurality of different types of polymerizable materials is selected to polymerize into one or more soluble polymeric materials that are each fully soluble in a fluid (e.g., a solvent or a solution) not present in the resin and in which each of the other polymeric materials are insoluble, thereby forming the object.

In some embodiments, the process comprises treating the object in the fluid to thereby cause dissolution of the one or more soluble polymeric materials.

The invention further provides a process for forming a 3D object having a plurality of material regions, one or more of the plurality of material regions is soluble in a fluid not capable of solubilizing another of said plurality of material regions, the process comprising irradiating with a multi-wavelength light source, or a plurality of light sources for generating radiation of different wavelengths, a resin comprising two or more different types of polymerizable materials and two or more different types of light-sensitive materials,
at least two of said two or more light-sensitive materials are selected amongst radical and ionic initiators,
wherein each of the two or more different types of polymerizable materials is polymerized into a different polymeric material by a different initiator of the at least two initiators in response to irradiation by light generated from the light source, said light being of a predetermined wavelength,
wherein one or more of the two or more different types of polymerizable materials is polymerized into one or more soluble polymeric materials that are each fully or partially soluble in the fluid not present in the resin and in which each of the other polymeric materials are insoluble, thereby forming the object.

In some embodiments, the process comprising treating the object in the fluid to thereby cause selective dissolution or decomposition of the one or more polymeric materials.

In some embodiments, the process comprising irradiating with a multi-wavelength light source, or a plurality of light sources a resin comprising two or more or a plurality of polymerizable materials and a plurality of corresponding radical and/or ionic initiators, wherein each of the plurality of different types of polymerizable materials is polymerized by a different initiator of the plurality of corresponding radical and/or ionic initiators into a different polymeric material, wherein one or more of the plurality of different types of polymerizable materials is polymerized into one or more soluble polymeric materials that are each fully soluble in the fluid not present in the resin and in which each of the other polymeric materials are insoluble, thereby forming the object.

In some embodiments, a process of the invention comprises
irradiating the resin comprising two or more different types of polymerizable materials and two or more different types of light-sensitive materials, at least one of said two or more light-sensitive materials is a (or one or more or a plurality) radical and/or an ionic initiator, wherein each of the two or more different types of polymerizable materials is polymerized into a different polymeric material by a different initiator in response to irradiation by a light of a predetermined wavelength, wherein one or more of the two or more different types of polymerizable materials is selected to polymerize into one or more soluble polymeric materials that are each fully soluble in a fluid (e.g., a solvent or a solution) not present in the resin and in which each of the other polymeric materials are insoluble;
wherein said irradiating comprising directing the multi-wavelength device or the plurality of light sources generating radiation of different wavelengths in a direction of the resin to initiate or induce selective polymerization of each of the two or more different types of polymerizable material in different regions of the resin to yield the 3D object; and
treating the object in the fluid to cause dissolution of the one or more soluble polymeric materials in the fluid, maintaining intact each of the other polymeric materials present in the object.

The invention further provides a vat photopolymerization process, the process comprising
irradiating a resin comprising two or more different types of polymerizable materials and two or more different types of light-sensitive materials,
at least two of said two or more light-sensitive materials are selected from radical and ionic initiators, wherein each of the two or more different types of polymerizable materials is polymerized into a different polymeric material by a different initiator of the at least two initiators,
wherein one or more of the two or more different types of polymerizable materials is polymerized into one or more soluble polymeric materials that are each partially or fully soluble in a fluid selected from a solvent and a solution, said fluid not present in the resin and in which each of the other polymeric materials are insoluble;
wherein said irradiating comprising directing a multi-wavelength device or a plurality of light sources generating radiation of different wavelengths in a direction of the resin to initiate or induce selective polymerization of each of the two or more different types of polymerizable materials in different regions of the resin to yield the 3D object; and
treating the object in the fluid to cause dissolution of the one or more soluble polymeric materials in the solvent or the solution, maintaining intact each of the other polymeric materials present in the object.

The invention further provides a vat photopolymerization process, the process comprising
obtaining a resin comprising two or more different types of polymerizable materials and two or more different types of light-sensitive materials, at least two of said two or more light-sensitive materials are selected from radical and ionic initiators, wherein each of the two or more different types of polymerizable materials is polymerizable selectively by (only) one of the at least two initiators (and not by any of the other initiator present in the resin) into a polymeric material,
provided that one or more of the two or more different types of polymerizable materials is configured to polymerize into one or more soluble polymeric materials partially or fully soluble in a pre-selected fluid, said fluid not present in the resin and is one in which each of the other polymeric materials are insoluble;
irradiating the resin by light comprising a plurality of distinct wavelengths generated by a multi-wavelength device or a plurality of light sources to initiate or induce selective polymerization of each of the two or more different types of polymerizable materials in different regions of the resin to yield the 3D object; and
treating the object in or contacting the object with the fluid to cause dissolution or decomposition or disintegration of the one or more soluble polymeric materials in the fluid, maintaining intact each of the other polymeric materials present in the object.

The invention further provides a multi-material vat photopolymerization process for simultaneously and selectively polymerizing a plurality of polymerizable materials in a resin into a 3D multi-material object, the process comprising
operating a multi-wavelength light source or a plurality of light sources to produce an irradiation beam comprising a plurality of discrete wavelengths, one wavelength per initiator present in the resin,
directing the irradiation beam in a direction of the resin comprising two or more different types of polymerizable materials and two or more radical and/or ionic initiators, to thereby cause selective polymerization of each of the different types of polymerizable materials into a different polymeric material,
wherein one or more of the two or more different types of polymerizable materials is polymerized into one or more soluble polymeric materials that are each fully or partially soluble a fluid not present in the resin and in which each of the other polymeric materials are insoluble, thereby forming the object.

Processes of the invention are carried out in a vat (vessel) comprising the resin. The resin is cured by polymerization, e.g., photopolymerization, using a light source as defined herein, typically, UV, visible and/or NIR irradiation, where light of several distinct wavelengths is directed across the surface of the resin with the use of motor-controlled mirrors or by directing several irradiation beams across the resin surface. Where an initiator comes in contact with light of a distinct wavelength, it activates to cure or cause polymerization of the polymerizable materials.

The vat typically comprises a build platform on which the object is formed and supported. During processing, the build platform is lowered from the top of the resin vat downwards by a layer thickness. Light of distinct wavelengths cures the resin layer by layer. The platform continues to move downwards as layers are formed, each typically being composed of one or a plurality of polymeric materials, and additional layers are built on top of the previous. After process completion, the vat is drained of the remaining resin and the object removed and post-treated.

The multi-wavelength device used in embodiments of the invention may be any multi-wavelength device which comprises a dual-wavelength digital light processing (DLP) projector, or two DLP projectors of which one displays a UV irradiation wavelength and a second displays visible light or NIR irradiation. In some configurations, the device comprises a dual-wavelength DLP projector, or two DLP projectors of which, one displays a UV irradiation wavelength between 300-375 nm and a second DLP projector displays visible light irradiation between 400-700 nm, e.g. 365 nm and 460 nm irradiation wavelengths, or a dual-wavelength DLP projector with 365 nm and 405 nm, respectively, a dual-wavelength DLP projector with 365 nm and 550 nm, a dual-wavelength DLP projector with 365 nm and 600 nm, respectively.

In some embodiments, a multi-wavelength device may comprise a dual-laser device or two lasers, of which one laser displays a UV irradiation between 300-375 nm and a second laser displays a visible light irradiation between 400-700 nm.

In some embodiments, the device may comprise a dual laser array with 365 nm and 405 nm, respectively, or a dual-laser array with 355 nm and 405 nm, respectively.

In some embodiments, the device comprises a dual laser array with 355 nm and 460 nm, or a dual laser array with 365 nm and 530 nm.

As disclosed herein, objects formed by utilizing a process of the invention are typically 3-dimentional (3D) multi-material objects having two or more or a plurality of different material regions, wherein each of the regions differs in material composition stemming from the different light-sensitive or polymerizable material (monomers and/or oligomers) used to form the region and thus defines a region of a different profile. At least one of the material regions differs from other material regions in solubility, permitting selective dissolution of the material region in a solvent or a solution, while leaving other regions of the object intact or unaffected.

The “profile” defining each of the regions may be any one or more of solubility, texture, color, mechanical, as well as other properties. In other words, each of the light-sensitive or polymerizable materials is selected to selectively transform or polymerize into a different material, e.g., a polymeric material, differing from another material in the object in having a predetermined solubility, texture, color, mechanical properties, etc.

An example of such an object is a support structure comprising vertically stacked objects manufactured by vat photopolymerization, as described hereinabove. In such a process, the support structure may be formed of a photopolymerizable material that is different from that used for forming the objects. The photopolymerizable material used to form the support structure may polymerize into a polymer having a profile that is different from that of the polymer of the objects, such that one polymer may be more reactive or less reactive, e.g., a higher or a lower or a different solubility than the other polymer, permitting selective or chemoselective dissolution of the support structure, leaving the objects unaffected and free therefrom.

As used herein, the term “selective” or “chemoselective” means a reactivity that is based on the chemical composition of one polymer versus the other. Where used in an expression such as “ . . . to selectively polymerize a polymerizable material . . . ” or “ . . . to induce selective polymerization . . . ”, the term suggests polymerization of a predetermined type of the material for which the initiator is specifically intended or selected.

The “light-sensitive material” is any material that upon irradiation with a light source of a given wavelength is susceptible to undergoing a photo, a thermal, or a pH-induced transformation into a reactive species, i.e., a radical or an ion, in the case of the initiations or into a different material in case other components used in the resin, as further discussed hereinbelow. The photoirradiation may by itself cause the transformation of the light-sensitive material; however, in some cases, photoirradiation may induce thermal or pH changes in the vicinity of the light-sensitive material, thereby causing its transformation. The transformation may be a structural transformation of any sort. The transformation may or may not involve bond breaking or bond formation. In some cases, the transformation comprises or involves a change in the material 3-dimensional orientation in space. The light-sensitive material may be silver halide photosensitive materials, diazo photosensitive materials, photosensitive resins, self-developing photosensitive materials, diffusion-transfer type photosensitive material, photosensitive spiro materials, and other materials which may change the color, cure or re-orientate in space, in response to light or induced heat or pH change.

In some embodiments, the resin comprises two or more light-sensitive materials of which at least one is an initiator and at least one other is a light-sensitive material capable of undergoing structural transformation in response to light of a specific wavelength, wherein the structural transformation optionally involving bond breaking or bond formation.

In some embodiments, the at least one other light-sensitive material is different from an initiator, such a material may be optionally selected amongst silver halide photosensitive materials, diazo photosensitive materials, photosensitive resins, self-developing photosensitive materials, diffusion-transfer type photosensitive materials, photosensitive spiro materials and materials capable of changing color, cure or re-orientate in space. In some embodiments, the resin comprises a light-sensitive material selected from silver halide photosensitive materials, diazo photosensitive materials, photosensitive resins, self-developing photosensitive materials, diffusion-transfer type photosensitive materials, photosensitive spiro materials and materials capable of changing color, cure or re-orientate in space.

Thus, the term “transform” or “transform the light-sensitive material into a different material” or any lingual variation thereof, encompasses any structural or conformational change in the light-sensitive material that results in a material that is different from the light-sensitive material in composition, chemical bonding, conformation in space, etc. The so-called “different material” being different from the light-sensitive material may have different characteristics or may render a region of the object with a different profile, e.g., may differ in solubility, texture, color, mechanical properties, etc.

In some embodiments, the light-sensitive material is a combination of two or more such materials, wherein one of which is an initiator.

In some embodiments, the light-sensitive material is a material capable of changing its color upon irradiation, wherein the change in color or transformation from a colorless material to a colored material may be due to structural changes or changes in the orientation of the molecules in space.

In some embodiments, the material capable of changing its color upon light irradiation is a pigment or a dye. The light-sensitive dyes may be selected from: (1) red/near IR light-sensitive dyes, such as, cyanine, squaraine derivatives, and others; (2) green light-sensitive dyes, such as, ferrocene, curcuminoid derivatives, and others; (3) purple, blue or UV light-sensitive dyes, such as, cyclohexanone, chalcones derivatives, and others.

In some embodiments, the resin comprises a polymerizable material and at least one light-sensitive material that is not polymerizable. In some embodiments, the light-sensitive material that is not polymerizable is a light-sensitive pigment or dye.

In some embodiments, the at least one of the polymerizable materials is a polymerizable material that changes its color upon polymerization.

As noted herein, one or more of the polymerizable material used in processes of the invention is/are configured or selected to polymerize into “soluble polymeric materials that are each fully or partially soluble in a fluid”. The one or more polymerizable materials are thus selected based on the solubility profile of the resulting polymer, which profile determined the fluid capable of causing their dissolution, decomposition or disintegration, while not affecting any of the other formed polymeric materials in the object. The fluid, as defined and selected, is not present in the resin and is not one in which each of the other polymeric materials is soluble. In other words, the fluid selectively and only solubilizes the polymer(s) obtained by polymerization of the particular polymerizable materials. The term “solubilize” or “dissolve” or dissolution” refers to a partial or a full decomposition or disintegration of a polymeric material in the fluid, as further discussed herein, by any solvent or solution derived material removal process.

The fluid used for the selective dissolution of a particular material region is one which is not present in the resin from which the object is formed. The fluid is typically a liquid material or a solvent that is selected to solubilize or dissolve one polymer but not another. The fluid may be a single solvent or a mixture of solvents, e.g., organic solvents, or a solution or an aqueous solution comprising water and one or more organic or inorganic materials. Non-limiting examples of fluids which may be used in accordance with the invention include acetone, THF, methanol, ethanol, DMSO, glycols, toluene, benzene, water, basic aqueous solutions with a pH=8-14, or acidic aqueous solitons with a pH=1-6.

In some embodiments, the dissolution of a soluble polymeric material or region made therefrom is full. Namely, the fluid is selected to fully and completely remove the polymeric material from the object while leaving intact the other material regions. The mechanism by which dissolution occurs is not important provided that material removal is achieved.

In some embodiments, a process of the invention further comprises providing a resin comprising two or more polymerization materials or sets of materials, wherein each material or each set comprises or consists of polymerizable monomers and corresponding initiators or catalysts, wherein the initiators or catalysts are selected to selectively induce polymerization of the monomers upon irradiation by light of a certain wavelength.

As stated herein, the “resin” is a homogenous solution or a dispersion or an emulsion which comprises reaction precursors (polymerizable materials), initiators (photoinitiators) and/or catalysts and potentially other agents and fillers (such as polymers, waxes, ceramic materials, sand, metal particles, or liquids, such glycols, oils and others), which may or may not be soluble in the resin composition. The resin may or may not comprise an inactive carrier medium, such as a solvent, e.g., water. The vat or reaction system holding the resin may be adapted to or provided with a built platform and one or a plurality of light sources. The resin may be provided as two or more sets of polymerizable materials, which are mixed into a single reaction mixture, forming the resin. Each of the material sets comprises (1) a polymerizable material and optionally a light-sensitive material, wherein the polymerizable material may be in a form of monomers and/or oligomers; and (2) an initiator or a catalyst capable of causing polymerization of the polymerizable monomers/oligomers, or transformation of the light-sensitive material in the set. In other words, a polymerizable material is provided with its corresponding initiator capable of inducing polymerization by light of a particular wavelength. In other words, only when irritated by a specific distinct wavelength, the polymerization of a predefined polymerizable material will occur. Thus, for example, a reaction mixture may comprise two polymerization material sets:
material set (1)—comprising monomers A, and an initiator capable of polymerizing monomers A under wavelength A′ to a polymer C;
material set (2)—comprising monomers B, and an initiator capable of polymerizing monomers B under wavelength B′ to polymer D.

The same applies to material sets comprising any two or more material combinations.

In the above example, the light of wavelength A′ will not cause the polymerization of monomers B, while wavelength B′ may cause the polymerization of A and B or B alone. It should be understood that while the composition is said to contain “two or more polymerization materials” or “sets”, all materials are admixed to provide a resin of ingredients from which the object is formed in response to selective radiation. As used in the example above, due to the different profiles, e.g., solubility profiles, associated with each of the resulting polymers (C and D in the example above) being part of an object of the invention, the constitution of the final object may be selectively modified. This may be achieved by immersing the object into a bath comprising a liquid medium capable of dissolving, solubilizing, or emulsifying one of the polymers while leaving the other polymers intact.

By another example:
material set (1)—comprising monomers E, and an initiator capable of polymerizing monomers E under wavelength E′ to a polymer F;
material set (2)—comprising a light-sensitive material G, and an initiator capable of transforming material G under wavelength G′ into a colored material H.

In this example, the light of wavelength E′ will not cause the transformation of material G, while wavelength G′ may cause the polymerization of E and transformation of G or G alone.

Each of the polymerizable materials or sets of materials comprises or consists of monomers/oligomers that polymerize by a different type of initiator or catalyst. The monomers/oligomers may be selected based on the way polymerization may be induced. In some embodiments, the monomers/oligomers are selected from such materials capable of undergoing photo-thermal polymerization, free-radical photopolymerization, radical thiol-ene photopolymerization, thermal latent cationic polymerization, cationic photopolymerization, and anionic photopolymerization. Thus, the initiators may be similarly selected amongst free-radical thermal radical initiators, free-radical photoinitiators, thermal latent cationic initiators, cationic photoinitiators, and anionic photoinitiators.

In some embodiments, a resin may comprise a polymerizable material comprising or consisting monomers or oligomers capable of undergoing thermal free radical polymerization or radical photopolymerization or thermal latent cationic polymerization or cationic photopolymerization, or anionic photopolymerization and may be provided with a corresponding initiator being a thermal radical initiator or a radical photoinitiator or a thermal latent cationic initiator or a cationic photoinitiator or an anionic photoinitiator, respectively, as well as combinations thereof.

In some embodiments, the monomers/oligomers are selected amongst such undergoing thermal or photo radical polymerization, such as radical thiol-ene photopolymerization. Such include ethylene, propylene, alkene, alkynes, styrene, acrylonitrile, acrylates and methacrylates, vinyl chlorides, primary and secondary thiols, and others. Examples of such monomers include nonyl phenol (4EO) acrylate, isobornyl acrylate (IBOA), phenoxyethyl acrylate (PEA), phenol (4EO) acrylate, o-phenylphenoxyethyl acrylate (OPPEOA), cyclic trimethylpropane formal acrylate (CTFA), tetrahydrofuryl acrylate (CTFA), 2-(2ethoxyethoxyl) ethyl acrylate (EOEOEA), octyl decyl acrylate (ODA), isodecyl acrylate (IDA), lauryl acrylate (LA), tripropyleneglycol monomethyl ethyl acrylate (TPGMEMA), hexanediol diacrylate (HDDA), bisphenol-A (4EO) diacrylate, polyethyleneglycol 200 diacrylate (PEG200DA), polyethylene glycol 300 diacrylate (PEG300DA), polyethyleneglycol 400 diacrylate (PEG400DA), polyethyleneglycol 600 diacrylate (PEG600DA), tripropyleneglycol diacrylate (TPGDA), 3-methyl-1,5-pentanediol diacrylate (MPDDA), neopnetylglycol (2PO) diacrylate (NPGPODA), dipropyleneglycol diacrylate (DPGDA), hexanediol (2EO) diacrylate (HD2EODA), hexanediol (2PO) diacrylate (HD2PODA), trimethylolpropane triacrylate (TMPTA), trimethylolpropane (3PO) triacrylate (TMP3POTA), glyceryl (4PO) triacrylate (GPTA), trimethylpropane (3EO) triacrylate (TMP3EOTA), trimethylpropane (9EO) triacrylate (TMP9EOTA), trimethylpropane (15EO) triacrylate (TMP15EOTA), tris(2-hydroxy ethyl) isocyanurate triacrylate (THEICTA), pentaerythriol tri and tetraacrylate, pentaerythritol (5EO) tatraacrylate (PPTTA), ditrimethylolpropane tetra-acrylate (DiTMPTA), dipentaerythritol hexaacrylate (DPPA), dipentaerythritol hexaacrylate (DPHA), acrylated epoxy soy oil (ESBOA), bisphenol A epoxy diacrylate, caprolactone acrylate (CA), 3,3,5-trimethyl cyclohexyl acrylate (TMCHA), 4-tert-butylcyclohexyl acrylate (TBCHA), benzyl acrylate (BZA), tridecyl acrylate (TDA), isodecyl acrylate (IDA), (PO)2 acrylate ethoxy ethoxy ethyl acrylate (EOEOEA), stearyl acrylate 1,6-hexandiol (5EO) diacrylate, hydroxypivalic acid neopentyl glycol diacrylate, neopentylglycol (2PO) diacrylate, dipropylene glycol diacrylate (DPGDA), triethylene glycol diacrylate (TEGDA), tricyclodecane dimethanol diacrylate (TCDDA), tetraethylene glycol diacrylate (TTEGDA), glycerine (3PO) triacrylate (GPTA), pentaerythritol triacrylate (PETIA), trimethylol propane (6EO) triacrylate (TMP(EO)6TA), 4-Acryloylmorpholine, pinene, terpinene, nerolidol, linalool, myrcene, limonene, carvone and oligomers thereof.

In some embodiments, the monomers/oligomers are selected amongst such undergoing thermal or photo ionic (cationic or anionic) polymerization. Such include aldehydes, epoxides, oxetanes, vinyl ethers, glycidyl ethers, lactams, lactones, and others. Non-limiting examples include allyl glycyl ether, bis[4-glycidyloxy)phenyl]methane, 1,3-butadiene diepoxide, 1,4-butanediol diglycidyl ether, butyl glycyl ether, tert-butyl glycidyl ether, 1,2,5,6-diepoxycyclooctane, 1,2,7,8-diepoxyoctane, diglycidyl 1,2-cyclohexane dicarboxylate, N,N-diglycidyl-4-glycidyloxyaniline, 1,2-diepoxybutane, 3,4-epoxy-i-butene, 3,4-epoxycyclohexylmethyl 3,4-epoxycyclohexanecarboxylate, 1,2-epoxydodecane, 1,2-epoxyhexadecane, 1,2-epoxyhexane, 1,2-epoxy-5-hexene, 1,2-epoxy-2-methylpropane, exo-2,3-epoxynorbornane, 1,2-cyclooctane, 1,2-diepoxypentane, 1,2-epoxy-3-phenoxypropane, (2,3-epoxypropyl) benzene, 1,2-epoxytetradecane, 2-ethylhexyl glycidyl ether, furfuryl glycidyl ether, glycerol diglycidyl ether, glycidyl hexadecyl ether, glycidyl isopropyl ether, glycidyl 4-methoxypohenyl ether, glycidyl 2-methylphenyl ether, isophrone oxide, 4,4′-methylenebis(N,N-diglycidylaniline), 2-methyl-2-vinyloxirane, neopentyl glycol diglycidyl ether, octyl glycidyl ether, decyl glycidyl ether, a-pinene oxide, propylene-oxide, resorcinol diglycidyl ether, styrene oxide, tris(2,3-epoxypropyl) isocyanurate, tris(4-hydroxyphenyl)methyl triglycidyl, 1,2-butylene oxide, 2,2′-{[(propane-2,2-diyl bis(cyclohexane-1,3-diyl))bis(oxy)] bis(methylene)] bis(oxyrane)}, 3-oxetanone, 3-bromooxetane, 3-iodooxentane, trimethylene oxide, 3-hydroxyoxetane, 3-aminooxetane, 0-butyrolactone, oxetane-3-carboxylic acid, 3-aminooxetane-3-carboxylic acid, oxetane-3-methanol, 3-(aminomethyl) oxetane, 3-amino-3-methyloxetane, N-methyl-3-aminooxetane, 2-(3-oextanylidine) acetonitrile, 3-methyl-3-oxetanecarboxaldehyde, 3-methyloxetane-3-carboxylic acid, 3-bromomomethyl-3-methyloxetane, 3,3-dimetheyloxetane, 3-methyl-3-oxetanemethanol, 1-(3-methyloxetan-3-yl)methanamine, 3-ethyl-3-oxetanemethanol, 3-(phenxymethyl)-3-oxetanylamine, his[4-(glycidyloxyl)phenyl]methane

In some embodiments, the monomers are selected amongst acrylate monomers. Non-limiting examples include nonyl phenol (4EO) acrylate, isobornyl acrylate (IBOA), phenoxyethyl acrylate (PEA), phenol (4EO) acrylate, o-phenylphenoxyethyl acrylate (OPPEOA), cyclic trimethylpropane formal acrylate (CTFA), tetrahydrofuryl acrylate (CTFA), 2-(2ethoxyethoxyl) ethyl acrylate (EOEOEA), octyl decyl acrylate (ODA), isodecyl acrylate (IDA), lauryl acrylate (LA), tripropyleneglycol monomethyl ethyl acrylate (TPGMEMA), hexanediol diacrylate (HDDA), bisphenol-A (4EO) diacrylate, polyethyleneglycol 200 diacrylate (PEG200DA), polyethylene glycol 300 diacrylate (PEG300DA), polyethyleneglycol 400 diacrylate (PEG400DA), polyethyleneglycol 600 diacrylate (PEG600DA), tripropyleneglycol diacrylate (TPGDA), 3-methyl-1,5-pentanediol diacrylate (MPDDA), neopnetylglycol (2PO) diacrylate (NPGPODA), dipropyleneglycol diacrylate (DPGDA), hexanediol (2EO) diacrylate (HD2EODA), hexanediol (2PO) diacrylate (HD2PODA), trimethylolpropane triacrylate (TMPTA), trimethylolpropane (3PO) triacrylate (TMP3POTA), glyceryl (4PO) triacrylate (GPTA), trimethylpropane (3EO) triacrylate (TMP3EOTA), trimethylpropane (9EO) triacrylate (TMP9EOTA), trimethylpropane (15EO) triacrylate (TMP15EOTA), tris(2-hydroxy ethyl) isocyanurate triacrylate (THEICTA), pentaerythriol tri and tetraacrylate, pentaerythritol (5EO) tatraacrylate (PPTTA), ditrimethylolpropane tetra-acrylate (DiTMPTA), dipentaerythritol hexaacrylate (DPPA), dipentaerythritol hexaacrylate (DPHA), acrylated epoxy soy oil (ESBOA), bisphenol A epoxy diacrylate, caprolactone acrylate (CA), 3,3,5-trimethyl cyclohexyl acrylate (TMCHA), 4-tert-butylcyclohexyl acrylate (TBCHA), benzyl acrylate (BZA), tridecyl acrylate (TDA), isodecyl acrylate (IDA), (PO)2 acrylate ethoxy ethoxy ethyl acrylate (EOEOEA), stearyl acrylate 1,6-hexandiol (5EO) diacrylate, hydroxypivalic acid neopentyl glycol diacrylate, neopentylglycol (2PO) diacrylate, dipropylene glycol diacrylate (DPGDA), triethylene glycol diacrylate (TEGDA), tricyclodecane dimethanol diacrylate (TCDDA), tetraethylene glycol diacrylate (TTEGDA), glycerine (3PO) triacrylate (GPTA), pentaerythritol triacrylate (PETIA), trimethylol propane (6EO) triacrylate (TMP(EO)6TA), 4-Acryloylmorpholine and combinations thereof.

In some embodiments, the monomers or oligomers are selected amongst cationic monomers/oligomers. Non-limiting examples include allyl glycyl ether, bis[4-glycidyloxy)phenyl]methane, 1,3-butadiene diepoxide, 1,4-butanediol diglycidyl ether, butyl glycyl ether, tert-butyl glycidyl ether, 1,2,5,6-diepoxycyclooctane, 1,2,7,8-diepoxyoctane, diglycidyl 1,2-cyclohexanedicarboxylate, N,N-diglycidyl-4-glycidyloxyaniline, 1,2-diepoxybutane, 3,4-epoxy-I-butene, 3,4-epoxycyclohexylmethyl 3,4-epoxycyclohexanecarboxylate, 1,2-epoxydodecane, 1,2-epoxyhexadecane, 1,2-epoxyhexane, 1,2-epoxy-5-hexene, 1,2-epoxy-2-methylpropane, exo-2,3-epoxynorbornane, 1,2-cyclooctane, 1,2-diepoxypentane, 1,2-epoxy-3-phenoxypropane, (2,3-epoxypropyl) benzene, 1,2-epoxytetradecane, 2-ethylhexyl glycidyl ether, furfuryl glycidyl ether, glycerol diglycidyl ether, glycidyl hexadecyl ether, glycidyl isopropyl ether, glycidyl 4-methoxypohenyl ether, glycidyl 2-methylphenyl ether, isophrone oxide, 4,4′-methylenebis(N,N-diglycidylaniline), 2-methyl-2-vinyloxirane, neopentyl glycol diglycidyl ether, octyl glycidyl ether, decyl glycidyl ether, a-pinene oxide, propylene-oxide, resorcinol diglycidyl ether, styrene oxide, tris(2,3-epoxypropyl) isocyanurate, tris(4-hydroxyphenyl)methyl triglycidyl, 1,2-butylene oxide, 2,2′-{[(propane-2,2-diyl bis(cyclohexane-1,3-diyl))bis(oxy)] bis(methylene)] bis(oxyrane)}, 3-oxetanone, 3-bromooxetane, 3-iodooxentane, trimethylene oxide, 3-hydroxyoxetane, 3-aminooxetane, P-butyrolactone, oxetane-3-carboxylic acid, 3-aminooxetane-3-carboxylic acid, oxetane-3-methanol, 3-(aminomethyl) oxetane, 3-amino-3-methyloxetane, N-methyl-3-aminooxetane, 2-(3-oextanylidine) acetonitrile, 3-methyl-3-oxetanecarboxaldehyde, 3-methyloxetane-3-carboxylic acid, 3-bromomomethyl-3-methyloxetane, 3,3-dimetheyloxetane, 3-methyl-3-oxetanemethanol, 1-(3-methyloxetan-3-yl)methanamine, 3-ethyl-3-oxetanemethanol, 3-(phenxymethyl)-3-oxetanylamine, bis[4-(glycidyloxyl)phenyl]methane and combinations thereof.

The polymerizable material configured and selected to polymerize into a soluble polymer may be selected based on the fluid in which intended dissolution is desired. As noted herein, the fluid used for dissolution or decomposition of a fluid-soluble polymeric material or region may be a solvent, such as an organic solvent or mixture of solvents, or water or an aqueous solution. Where the fluid selected for dissolution or decomposition of a fluid-soluble polymeric material or region is or comprises water, one or more of the polymers must be water-soluble (photo)polymers, while the other must be water-insoluble polymers.

In some embodiments, the polymerizable material configured to polymerize in a fluid-soluble, e.g., water-soluble, polymeric material, is a monomer or an oligomer selected from acrylic acid, methacrylic acid, methacrylamide, N,N-dimethylacrylamide, vinyl pyrrolidone, acryl-amide, 2-acrylamido-2-methylpropan-1-sulfonic acid, sodium vinyl sulfonate, or sodium-4-vinylbenzenesulfonate, 4-acryloylmorpholine (ACMO), and others.

The initiator utilized in accordance with the invention is a polymerization initiator that is selected to transform under light of a predetermined wavelength, generated from the light source, into a reactive species, e.g., a radical or an ion that is capable of causing or initiating polymerization of the polymerizable material. Each of the initiators is capable of causing polymerization of a different polymerizable material. Where one initiator is capable of initiating a respective polymerizable material, it will not cause polymerization of a different polymerizable material present.

In some embodiments, the initiator is selected amongst thermal or photo-radical initiators.

In some embodiments, the initiator is selected from azobisisobutyronitrile (AIBN); 2,2′-azobis(2-methylpropionitrile) (AMBN); 2,2′-azobis (2,4 dimethylvaleronitrile) (ADVN); 4,4′-azobis(4-cyanopentanoic acid) (ACVA); dimethyl 2,2′-azo-bis(2-methylpropionate); 2,2′-azobis(2-methylpropionamidine) dihydrochloride (AAPH); acetophenones, such as 2;2-dimethoxy-2-phenylacetophenone; hydroxyacetophenones, such as 2-hydroxy-2-methyl-1-phenylpropanone; 1-hydroxycyclohexyl phenyl ketone; 1-[4-(2-hydroxyethoxy)-phenyl]-2-hydroxy-2-methyl-1-propane-i-one; oligo[2-hydroxy-2-methyi-1-[4-(1-methylvinyl)phenyl]propanone]; aminoacetophenones, such as 2-benzyl-2-dimethylamino-4-morpholinobutyro phenome: benzophenones such as 4-methylbenzophenone, methyl-2-benzoylbenzoate, 4,4′-bis(diethylamino)benzophenone; 4-benzoyl-4′-methyldiphenyl sulphide, 4-phenyl benzophenone; camphorquinone; thioxanthanones, such as 2-isopropylthioxanthone, 1-chloro-4-propoxythioxanthone, 24-diethylthioxanthone; benzylformates, such as methylbenzoylformate; bis(1l-2,4-cylopendien-1-yl)bis[2,6-difluoro-3-(1H-pyrrol-1-yl)phenyl]titanium (IV); tert-butyl hydroperoxide (TBHP); di-t-butyl peroxide; phenylbis(2,4,6-trimethylbenzoyl)phosphine oxide (BPO); diphenyl (2,4,6-trimethyl-benzoy)phosphine oxide (TPO); ethyl (2,4,6-trimethylbenzoyl) phenyl phosphinate (TPO-L); lithium phenyl(2,4,6-trimethylbenzoyl)phosphinate; 1-[4-(phenylthio)phenyl]-3-cyclopentylpropane-1,2-dione-2(O-benzoyloxime); and others.

In some embodiments, the initiator is selected amongst thermal or photo ionic (cationic or anionic) initiators. Such initiators may include triphenyliodonium salts, such as bis(4-dodecylphenyl)iodonium hexafluoroantimonate, bis-(4-t-butylphenyl)-iodonium hexafluorophosphate, 4-isopropyl-4′-methyldiphenyliodonium; tetrakis(pentafluorophenyl) borate; triphenylsulfonium salts, such as (sulfanediyldibenzene-4,1-diyl)bis(diphenylsulfonium)bis(hexafluoroantimonate), diphenyl sulfonium salts; porphyrins such as tetraphenylporphyrin, zinc tetraphenylporphyrin; acylgermanes; diacylgermanes; tris(bipyridine)ruthenium(II) chloride; tris(1,10-phenanthroline-5,6-dione)ruthenium(II) bis(hexafluorophosphate); tris[2-phenylpyridinato-C²,N]iridium(III); or tris(1-phenylisoquinoline)iridium (III) and others.

In some embodiments, the resin comprising the polymerizable material, e.g., in a form of monomers or oligomers or mixtures thereof, the initiator and optionally other materials, may also comprise an amine, or a thiol synergist. The amine synergist may be a primary, a secondary, a tertiary, or a polymeric amine, e.g., such as ethyl-4-(dimethylamino)benzoate, 2-ethylhexyl-4-(dimethylamino)benzoate, 2-butoxyethy]-4-(dimethylarino)benzoate, or 2-(dimethylamino) ethylbenzoate. The thiol synergist may be, for example, dodecathiol, pentaerythritol tetrakis(mercaptoacetate), pentaerythriol tetrakis(3-mercaptopropionate), or trimethylolpropane-tris(mercaptoacetate). Other amine or thiol synergists may also be possible.

In some embodiments, the resin may contain an amine, a thiol, or thioxanthone synergist.

In some embodiments, a resin used according to the invention may comprise:
(1) A first polymerizable material set comprising:
a monomer selected from monomers undergoing thermal or photo radical polymerization, e.g., ethylene, propylene, styrene, acrylonitrile, acrylates and methacrylates, vinyl chlorides, terpenes, epoxy acrylates and others, or any of the monomers disclosed herein; and
an initiator selected from thermal or photo radical initiators, e.g., azobisisobutyronitrile (AIBN); 2,2′-azobis(2-methylpropionitrile) (AMBN); 2,2′-azobis (2,4 dimethylvaleronitrile) (ADVN); 4,4′-azobis(4-cyanopentanoic acid) (ACVA); dimethyl 2,2′-azo-bis(2-methylpropionate); 2,2′-azobis(2-methylpropionamidine) dihydrochloride (AAPH); acetophenones, such as 2,2-dimethoxy-2-phenylacetophenone; hydroxyacetophenones, such as 2-hydroxy-2-methyl-1-phenylpropanone, 1-hydroxycyclohexyl phenyl ketone, 1-[4-(2-hydroxyethoxy)-phenyl]-2-hydroxy-2-methyl-1-propane-I-one; oligo[2-hydroxy-2-rnethyl-1-[4-(1-methylvinyl)phenyl]propanone]; aminoacetophenones, such as 2-benzyl-2-dimethylarnino-4-mnorpholinobutyrophenone; benzophenones, such as benzophenone, 4-methylbenzophenone, methyl-2-benzoylbenzoate, 4,4′-bis(diethylamnino)benzophenone, 4-benzoyl-4′-methyldiphenyl sulphide, 4-phenylbenzophenone; camphorquinone, thioxanthanones, such as 2-isopropylthioxanthone, 1-chloro-4-propoxythioxanthone, 2,4-diethylthioxanthone; benzylformates, such as methylbenzoylformate; bis(1⁵-2,4-cylopendien-1-yl)bis[2,6-difluoro-3-(1H-pyrrol-1-yl)phenyl]titanium (IV); terbuty] hydroperoxide (TBHP); di-t-butyl peroxide; phenylbis(2,4,6-trimethylbenzoyl)phosphine oxide (BPO); diphenyl (2,4,6-trimethyl-benzoy)phosphine oxide (TPO); ethyl (2,4,6-trimethylbenzoyl) phenyl phosphinate (TPO-L); lithium phenyl(2,4,6-trimethylbenzoyl)phosphinate; 1-[4-(phenylthio)phenyl]-3-cyclopentylpropane-1,2-dione-2-(O-benzoyloxime), and others;
(2) A second polymerizable material set comprising:
a monomer selected amongst monomers undergoing thermal or photo ionic (cationic or anionic) polymerization, e.g., aldehydes, epoxides, oxetanes, vinyl ethers, glycidyl ethers, lactams, lactones and others or any of the monomers disclosed herein; and
an initiator selected from thermal or photo ionic (cationic or anionic) initiators, e.g., triphenyliodonium salts, such as bis(4-dodecylphenyl)iodonium hexafluoroantimonate, bis-(4-t-butylphenyl)-iodonium hexafluorophosphate, 4-isopropyl-4′-methyldiphenyliodonium; tetrakis(pentafluorophenyl)borate; triphenylsulfonium salts, such as (sulfanediyldibenzene-4,1-diyl)bis(diphenylsulfonium)bis-(hexafluoroantimonate); diphenyl sulfonium salts; porphyrins such as tetraphenylporphyrin, zinc tetraphenylporphyrin; acylgermanes, diacylgermanes; tris(bipyridine)ruthenium(II) chloride; tris(1,10-phenanthroline-5,6-dione)ruthenium(II) bis(hexafluorophosphate); tris[2-phenylpyridinato-C²,N]iridium(III); and tris(1-phenylisoquinoline)iridium(III).

In some embodiments, the resin comprises an acrylate monomer and a corresponding initiator; and an epoxide-based monomer and a corresponding initiator.

In some embodiments, the resin comprises an acrylate monomer and a corresponding initiator; and an oxetane-based monomer and a corresponding initiator.

In some embodiments, the resin comprises a methacrylate monomer and a corresponding initiator; and an epoxide-based monomer and a corresponding initiator.

In some embodiments, the resin comprises a methacrylate-monomer and a corresponding initiator; and an oxetane-based monomer and corresponding initiator.

In some embodiments, the resin comprises a terpene and thiol monomer and a corresponding initiator; and an oxetane-based monomer and corresponding initiator.

The “corresponding initiator” is an initiator that is selected based on the wavelength required for its activation/decomposition, for generating a reactive species such as a radical or a cation that is capable of causing polymerization of the polymerizable material to which it corresponds.

In some embodiments, the resin comprises a monomer that polymerizes upon reaction with a radical initiator to form a fluid-soluble e.g., a water-soluble, polymer and an epoxy or oxetane monomer that polymerizes in the presence of a cationic initiator, to provide a polymerized material that is not soluble in the fluid, e.g., insoluble in water.

In some embodiments, the resin comprises a monomer or a mixture of monomers that polymerizes upon reaction with a cationic initiator to form a fluid-soluble, e.g., water-soluble, polymer, and a (meth)acrylate monomer mixture that polymerizes in the presence of a radical initiator, resulting in a polymerized material that is not soluble in the solvent, e.g., that is water insoluble.

In some embodiments, the resin comprises
a monomer that polymerizes upon reaction with a radical initiator to form a fluid-soluble polymer, e.g., a water soluble polymer; and
an epoxy or oxetane monomer mixture and a filler, wherein the epoxy or oxetane monomer polymerizes in presence of a cationic initiator, resulting in a polymer-filler composite material that is not soluble in the fluid, e.g., in water.

In some embodiments, a resin used according to the invention may further comprise at least one filler. The filler is typically a material that is not reactive to radiation or ionic initiation and which is thus naïve or insert under the processing conditions. In some configurations, the filler may be selected based on the purpose it is intended to fulfill in the final object and may thus necessitate, in some cases, further post-treatment processing, such as thermal treatments.

The filler may be selected from a ceramic filler, sand, and a metal filler, each of which constituting a separate embodiment.

Non-limiting examples of fillers may include, for example, alumina, zirconia, silica, silicon nitride, silicon carbide, tricalcium phosphate, hydroxyapatite, kaolin, lithium-disilicate, Leucite, steel, stainless steel, aluminium, copper, Inconel, titanium, cobalt-chrome, tungsten. In some embodiments, the filler may be provided in a form of particles being micron in size (or diameter), wherein the size typically in in the range of 1 μm-300 μm, or in a nanometre size (or diameter), wherein the size is in the range of 20 and 100 nm.

In some embodiments, the polymer-filler composite is selected from a ceramic-polymer, a sand-polymer, or metal-polymer composite.

In some embodiments, a process of the invention is configured for manufacturing an object comprising a polymer-filler composite. The polymer-filler composite may be selected from a ceramic-polymer, a sand-polymer, and a metal-polymer composite. In some embodiments, the polymer in the polymer-filler composite is partially or fully soluble or decomposable in a fluid such as water.

In some embodiments, the process comprises a step of treating the object in a fluid such as water or any fluid selected to solubilize or decompose the polymer in the composite.

The invention further provides a process for manufacturing a 3D object of a polymer-filler composite, the process comprising irradiating a resin comprising at least two different types of a polymerizable material, at least two radical and/or ionic initiators or catalysts, and at least one filler, each of the at least two initiators being selected to selectively polymerize a polymerizable material of the at least two different types of the polymerizable material under exposure to a predetermined wavelength; said irradiating comprises directing a multi-wavelength irradiation device, or a plurality of light sources generating radiation of different wavelengths in a direction (or different directions or areas) of the resin to thereby induce selective polymerization of the at least two different types of the polymerizable material to yield the 3D object.

Further provided is a process for forming a 3D object comprising a polymer-filler composite, one or more of the plurality of material regions is soluble in a fluid not capable of solubilizing another of said plurality of material regions, the process comprising
irradiating with a multi-wavelength light source, or a plurality of light sources for generating radiation of different wavelengths, a resin comprising two or more different types of polymerizable materials, two or more different types of light-sensitive materials and at least one filler, as defined herein,
at least two of said two or more light-sensitive materials are selected amongst radical and ionic initiators,
wherein each of the two or more different types of polymerizable materials is polymerized into a different polymeric material by a different initiator of the at least two initiators in response to irradiation by light generated from the light source, said light being of a predetermined wavelength,
wherein one or more of the two or more different types of polymerizable materials is polymerized into one or more soluble polymeric materials that are each fully or partially soluble in the fluid not present in the resin and in which each of the other polymeric materials are insoluble, thereby forming the object.

In some embodiments, the is unreactive under the processing conditions, e.g., unreactive to the initiators.

In some embodiments, the polymer-filler composite comprises separate polymer and filler regions. In some embodiments, the polymer-filler composite comprises at least one material region in which the polymer and the filler are intermixed.

In some embodiments, the resin comprises at least two material sets, each material set comprising at least one type of polymerization monomer or oligomer and at least one initiator, as disclosed herein, wherein at least one of the material sets comprises the filler.

In some embodiments, the filler is ceramic, a metal filler, fiber, polymer, wax, or a sand filler.

In some embodiments, the filler is nano- or microparticle, or a mixture of particles.

In some embodiments, the 3D object of a polymer-filler composite is an object formed of or comprising or is (consisting) a ceramic object, a metal-polymer-ceramic object, a polymer-metal object, a polymer-sand object, a polymer-polymer, and polymer-fiber object, etc.

In some embodiments, the process further comprises a step of immersing the object in a liquid medium (being a fluid, e.g., water or water containing) capable of solubilizing one of the material regions making up the composite, e.g., the polymer, the polymer-ceramic, the polymer-metal, the polymer-fiber, the polymer-wax or the polymer-sand regions, to thereby clear the object from said material leaving behind the material regions that are insoluble in the medium.

In some embodiments, the process further comprises a stage of heat treating the object in oxygen, air, or in an inert gas environment. In some cases, this thermal stage may comprise de-binding the polymer from the ceramic-polymer, ceramic-metal, or ceramic-sand composite, by utilizing thermal radiation, microwave radiation, pressure, or chemical treatment, and sintering the remaining material to bring about densification of the ceramic, metal, or sand object, hence yielding a ceramic, metal, or a sand object.

In some embodiments, the resin comprises two or more polymerizable material sets, at least one of which comprises monomers of a first type, particles of a filler material, and an initiator or a catalyst capable of polymerizing the monomers of the first type under a light of a first wavelength to form a composite of a polymer-filler particle.

In some embodiments, the resin may comprise monomers of a further type and an initiator or a catalyst capable of polymerizing the monomers of the further type under a light of a further wavelength.

In some embodiments, the light of the further wavelength may not cause polymerization of the monomers of the first type, while the first wavelength may cause polymerization of the monomers of the first type and the further type or the first type only.

In some embodiments, the filler particles may be of a material selected from ceramics, metals, sand, metal salts, waxes, polymers, and combinations thereof.

In some embodiments, the resin comprises two or more polymerizable material sets, at least one of which comprises monomers of a first type, particles of filler material, and an initiator or a catalyst capable of polymerizing the monomers of the first type under a light of a first wavelength to form a composite of a polymer-filler particle; and monomers of a further type and an initiator or a catalyst capable of polymerizing the monomers of the further type under a light of a further wavelength, to thereby form an object having at least two material regions, e.g., a first region being a composite region of the first polymer and the filler and a further region being a polymer region of the further polymeric material.

It should be understood that while the resin is said to contain “two or more polymerizable material sets”, or two or more or at least two or a plurality of material sets, or any variation thereof, all materials are admixed to provide a resin or a combination of ingredients from which the object is formed in response to selective radiation. As a person of knowledge in the art would appreciate, the presence of different material regions, having different attributes or a different profile, as defined, e.g., different solubility profiles, the constitution of the final object may be selectively modified. Where different solubilities are concerned, an object with soluble and insoluble regions may be manufactured, which may be modified by immersing the object into a bath comprising a liquid medium capable of dissolving, solubilizing, or emulsifying the soluble material region, e.g., one of the polymers, or polymer-composites while leaving the other polymers, or polymer-composite intact.

By utilizing polymerizable monomers capable of selectively transforming into other materials or polymerizing into polymers or polymer composites of different profiles, objects of the invention may be multicolored objects, having two or more regions of different colors, color tones, or hues. The coloring may be accompanied by one or more additional functionalities or properties, such that a profile of each different region may be distinguishable from profiles of other regions in their colors or at least in their colors.

In some embodiments, the process is tailored for manufacturing a multicolored object, having two or more regions of different colors, color tones, or hues.

In some embodiments, the process comprises irradiating a resin comprising at least two light-sensitive materials, at least one of which being a polymerizable material and at least a second of which being a light-sensitive pigment capable of transforming into a colored material or a polymerizable material capable of polymerizing into a colored polymer.

In some embodiments, at least one of the polymerizable materials is a monomer or an oligomer that has a color before polymerization and which maintains its color following polymerization.

In some embodiments, at least one of the polymerizable materials polymerizes into a colored polymer or polymer composite.

In some embodiments of a process of the invention, the process being for forming a multicolored object, the process may comprise a resin that comprises one or more different polymerizable materials and at least two light-sensitive materials, at least one of which is the initiator and at least a second of which is a light-sensitive pigment capable of transforming into a colored material or a polymerizable material capable of polymerizing into a colored polymer. In some embodiments, at least one of the polymerizable materials is a monomer or an oligomer that has a color before polymerization and which maintains its color following polymerization. In some embodiments, at least one of the polymerizable materials, e.g., monomer, or oligomer, polymerizes into a colored polymer or polymer composite, as defined herein.

In some embodiments, the resin comprises a colorless (being white or clear, transparent or substantially transparent) monomer mixture that polymerizes upon reaction with an initiator, e.g., a radical initiator, to form a colorless polymer and a colored epoxy or oxetane monomer mixture or a dye mixture comprising an oxetane or epoxy functional group that polymerizes in the presence of a cationic initiator, resulting in a colored polymer.

In some embodiments, the resin comprises a colored (having a color different from white) monomer mixture, or a polymerizable dye comprising an acrylate or methacrylate functional group that polymerizes upon irradiation with a radical initiator to form a colored polymer and a colorless epoxy or oxetane mixture that polymerizes in the presence of a cationic initiator resulting in a colorless polymer.

In some embodiments, the resin comprises a mixture of monomers that polymerize upon reaction with a radical or cationic initiator, or a combination of radical and cationic initiators to form a colored or colorless polymer.

In some embodiments, the resin may comprise a polymerizable material and a mixture of one or more photochromic, photoreactive or photochangable dyes, or pigments. The formation of the colored object can be achieved either in a further stage of the process, in which certain regions of the object are irradiated with wavelengths of a light that selectively deactivates one or more of the photochromic, photoreactive or photochangable dyes, or pigments used or during the 3D printing process by using of a multi-wavelength projector, yielding a multicolored object.

In some embodiments, a multicolored object may be obtained by means of using one or more photochromic, photoreactive, or photochangable dyes, or pigments.

As known in the art, photochromic, photoreactive or photochangable dyes or pigments are colored molecules, or particles displaying reversible, or irreversible optical properties, such as color, upon irradiation with light of a certain wavelength. This activation/deactivation process may be used in processes of the invention by selecting a proper wavelength that not only selectively induces polymerization of a specific polymerizable material, but can also activate or deactivate a photochromic, photoreactive or photochangable dye or pigments present in the resin.

The invention further provides a process, e.g., a vat photopolymerization process, for forming a multicolored 3D object, the process comprising irradiating with a multi-wavelength light source, or a plurality of light sources, generating radiation of different wavelengths, a resin comprising one or more different types of polymerizable materials, one or more radical and/or ionic initiators and one or more light-sensitive pigments or dyes, wherein each of the different types of polymerizable materials is polymerized into a different polymeric material by a different initiator in response to irradiation by light generated from the light source, said light being of a predetermined wavelength, and wherein at least one of the light-sensitive pigments or dyes is photoactivated to undergo a color change in response to light generated from the light source and having a wavelength that is different from the predetermined wavelength.

In some embodiments, to obtain a multicolored object using e.g., the vat photopolymerization printing processes of the invention, a resin comprising one or more photochromic, photoreactive or photochengable dyes or pigment may be used during the printing process, followed by selective irradiation with a distinct wavelength that induces a change in the optical properties (deactivation) of one or more dyes.

Formation of multicolor objects may be achieved using two different approaches: according to the first approach, a colored monomer or photopolymerisable dye is used in combination with a multiwavelength 3D printing process, according to the invention, allowing for selective polymerization and the formation of an object having different colored regions; in a second approach, a multicolored object may be achieved utilizing a reaction mixture comprising a mixture of photochromic, photoreactive or photochangable dyes or pigments may be used, wherein the formation of a colored object can be achieved during the 3D printing process by illuminating the respective regions with a second wavelength that selectively deactivates one or more of the photochromic, photoreactive or photochangable dyes or pigments. Alternatively, regions of the object may be selectively illuminated with a single distinct or a combination of multiple distinct wavelengths, to selectively change the optical properties of one, or multiple photochromic, photoreactive, or photochangable dyes or pigments.

In another aspect, the invention provides A process for forming a colored multi-material (3D) object, or an object having a plurality of material regions, the process comprising irradiating with a multi-wavelength light source, or a plurality of light sources generating radiation of different wavelengths, a resin comprising (i) one or more photochromic, photoreactive or photochangable dyes, or pigments, each being responsive to a light of a different wavelength, (ii) one or a plurality of different types of polymerizable materials, and (iii) one or a plurality of corresponding radical and/or ionic initiators selectively reactive under a predetermined wavelength (or a wavelength range) to polymerize a respective polymerizable material into a different polymeric material, wherein the wavelength to which the one or more photochromic, photoreactive or photochangable dyes, or pigments is responsive is different from the initiator predetermined wavelength.

Objects formed by processes of the invention may be many and different. Such objects may be ornamental objects, houseware objects, mechanical tools, mechanical elements, various devices, medical devices, implants, orthodontics, orthopedics, audiology devices, anatomical modeling, and others.

The invention further provides a device for manufacturing a 3D object, the device comprising
a vat configured for holding a resin, said resin being optionally as defined herein;
an illumination assembly comprising a multi-wavelength device or a plurality of light sources for generating and simultaneously directing a plurality of light beams of different wavelengths in a direction of (or to different regions of) the resin to thereby induce selective transformation of light-sensitive materials in accordance with their sensitivity to a given wavelength.

In some embodiments, the device comprises a dual-wavelength DLP projector or two DLP projectors of which, one displays a UV irradiation wavelength between 300-385 nm and a second DLP projector displays visible light irradiation between 400-700 nm, e.g. 365 nm and 460 nm irradiation wavelengths, or a dual-wavelength DLP projector with 365 nm and 405 nm, respectively, a dual-wavelength DLP projector with 365 nm and 550 nm, a dual-wavelength DLP projector with 365 nm and 600 nm, respectively.

In some embodiments, the dual-laser device or two lasers, of which one laser displays a UV irradiation between 300-385 nm and a second laser displays a visible light irradiation between 400-700 nm.

In some embodiments, the dual laser array with 365 nm and 405 nm, respectively, or a dual-laser array with 355 nm and 405 nm, respectively.

In some embodiments, the dual laser array with 355 nm and 460 nm, or a dual laser array with 365 nm and 530 nm.

The invention further provides a system for producing a three-dimensional object comprising a plurality of material regions, each material region having a different characteristic profile, the system comprising
a vat configured for containing a resin;
an exposure system with a multi-wavelength light source, or a plurality of light sources for generating light of different wavelengths, optionally one or more spatial light modulators with a plurality of individually controllable light modulators, input optics, and output optics, each optically coupled to said one or more spatial light modulator, wherein said input optics and output optics are configured to facilitate the transmission of light emitted from said multi-wavelength source or from each of the plurality of light sources via said individually controllable light modulators to an illumination area of the resin, wherein multi-wavelength light source, or a plurality of light sources, enable an establishment of an object with a plurality of material regions, each formed of a different light-sensitive material contained in said resin, in response to radiation by a different wavelength; and
a control unit.

### DETAILED DESCRIPTION OF THE INVENTION

### Examples

In the following section, several examples are presented to demonstrate some of the possibilities of utilizing the invention. These non-limiting examples show the possible approach to enable 3D printing objects with soluble and non-soluble segments using vat photopolymerization, as well as multi-colored objects using different methodologies. The presented approaches enable the fabrication of various structures and devices, including orthodontics applications such as anchoring with clear aligners.

### Example 1: Multi-Material 3D Printing with Solvent Soluble Supports

50 g of 4-acryloylmorpholine (ACMO, Rahn AG, Switzerland) were combined with 50 g of 3,4-epoxycyclohexylmethyl 3,4-epoxycyclohexanecarboxylate (UviCure S105, Lambson Ltd), 1 g of phenylbis(2,4,6-trimethylbenzoyl)phosphine oxide (SpeedCure BPO, Lambson Ltd), 2 g (sulfanediyldibenzene-4,1-diyl)bis(diphenylsulfonium)bis(hexa-fluoroantimonate) (SpeedCure S976s, Lambson Ltd), and 2 g 2-ethyl-9,10-dimethoxyanthracene (Sigma Aldrich) in a dark vessel. The reaction mixture was mixed for 60 minutes at 50° C. until all solids were visibly dissolved. The formulation was then placed into the resin tray of a dual-wavelength DLP 3D printer, with wavelengths of 365 nm and 450 nm, respectively. The 3-dimensional object was computer designed and converted into an STL file suitable for 3D printing with 2 different materials. The main body of the object was designed to be built with insoluble material, whereas the supports were designed to be built with soluble material.

The object was built in a layer-by-layer fashion, using a bottom-up 3D printing process, in which object areas that are meant to be soluble are illuminated with a wavelength of 450 nm whereas other areas are illuminated with 365 nm. Upon completion of the 3D printing process, the part was initially immersed for five minutes in isopropanol to remove excess resin. The support removal process was performed by immersing the 3D printed part into a wash unit containing a sodium hydroxide solution (pH=9) for 60 minutes at 80° C. The part was subsequently rinsed with cold water, and isopropanol, and post-cured under UV at 60° C. for 2 hours.

### Example 2: Multi-Material 3D Printing with Soluble Segments

25 g of 3-ethyloxetane-3-methanol (UviCure S130, Lamson Ltd) were combined with 25 g of bis((3,4-epoxycyclohexyl)methyl) adipate (UviCure S128, Lambson Ltd), 40 g of 4-acryloylmorpholine (ACMO, Rahn AG, Switzerland), 10 g of 3-sulfopropylacrylate potassium salt (Sigma Aldrich), 3 g of (sulfanediyldibenzene-4,1diyl)bis(diphenylsulfonium) bis(hexafluoroantimonate) (SpeedCure 976s, Lambson Ltd), 300 mg of 1-chloro-4-propoxythioxanthone (SpeedCure CPTX, Lambson Ltd) and 500 mg of phenylbis(2,4,6-trimethylbenzoyl)phosphine oxide (SpeedCure BPO, Lambson Ltd) in a dark vessel. The reaction mixture was mixed for 60 minutes at 50° C. until the visible dissolution of all solids. The formulation was then placed into the resin tray of a dual-wavelength DLP 3D printer, with wavelengths of 365 nm and 450 nm, respectively. The 3-dimensional object was computer designed and converted into an STL file suitable for 3D printing with two materials. The object was designed to have rigid, durable areas, as well as soluble areas. The object is built in a layer-by-layer fashion, using a bottom-up 3D printing process, in which object areas that are meant to be soluble are illuminated with a wavelength of 450 nm, whereas insoluble areas of the object are illuminated with 365 nm. Upon completion of the 3D printing process, the part is initially immersed for 5 minutes in isopropanol to remove excess resin. The support removal process was performed by immersing the 3D printed part into a wash unit containing tap water (pH=7) for 60 minutes at 80° C. The part was subsequently rinsed with cold water, isopropanol, and post-cured under UV at 60 degrees for 2 hours.

### Example 3: Multi-Material 3D Printing with Swellable Supports

25 g of 2-hydroxyethylacrylate (HEA, BASF GmbH, Germany) and 25 g of 4-acryloylmorpholine (ACMO, Rahn AG, Switzerland) were combined with 30 grams of 3-Ethyloxetane-3-methanol (UviCure S130, Lambson Ltd) and 20 g of 3,4-epoxycyclohexylmethyl 3,4-epoxycyclohexanecarboxylate (UviCure S105, Lambson Ltd., 3 grams of (sulfanediyldibenzene-4,1-diyl)bis(diphenylsulfonium)bishexafluoroantimonate) (SpeedCure 976s, Lambson Ltd.), 300 mg of 1-chloro-4-propoxythioxanthone (SpeedCure CPTX, Lambson Ltd.) and 500 mg of phenylbis(2,4,6-trimethylbenzoyl)phosphine oxide (SpeedCure BPO, Lambson Ltd.) in a dark vessel. The reaction mixture was mixed for 60 minutes at 50° C. until the visible dissolution of all solids. The formulation was then placed into the resin tray of a dual-wavelength DLP 3D printer, with wavelengths of 365 nm and 450 nm, respectively. The 3-dimensional object was computer designed and convert into an STL file suitable for 3D printing with 2 materials. The object was designed to have rigid, and durable areas, as well as swellable areas. The object was built in a layer-by-layer fashion, using a bottom-up 3D printing process, in which object areas that are meant to be soluble are illuminated with a wavelength of 450 nm, whereas non-swellable areas of the object are illuminated with 365 nm. Upon completion of the 3D printing process, the part is initially immersed for 5 minutes in isopropanol to remove excess resin. The support removal process was performed by immersing the 3D printed part into a wash unit containing tap water (pH=7) for 60 minutes at 80° C. to show a clear swelling of the designed areas. Adjacent areas of the part which were connected by the swellable material could be easily broken off. The part was subsequently rinsed with cold water, isopropanol and post cured under UV at 60° C. for 2 hours.

### Example 4: Multi-Material 3D Printing with Ceramic-Filled Resins

20 g of 3-ethyloxetane-3-methanol (SpeedCure S130, Lambson Ltd) 30 g of 3,4-epoxycyclohexylmethyl 3,4-epoxycyclohexanecarboxylate (UviCure S105, Lambson Ltd 50 g of acryloylmorpholine (ACMO, Rahn AG, Switzerland) were mixed in a dark reaction vessel. 50 g of spherical silica powder and an epoxy surface modification (Admafine, epoxy-silane treatment, Admatechs Co, Ltd.) was added slowly, portion-wise to the monomer mixture using a high shear mixer (Silverson L5 Series, Silverson Ltd). After the mixing was completed 3 g of (sulfanediyldibenzene-4,1-diyl)bis(diphenylsulfonium)bis-(hexafluoro antimonate) (SpeedCure 976S, Lambson Ltd.), 300 mg of 1-chloro-4-propoxythioxanthone (SpeedCure CPTX, Lambson Ltd.) and 500 mg of phenylbis(2,4,6-trimethylbenzoyl)phosphine oxide (SpeedCure BPO, Lambson Ltd.) were added and dissolved at 60° C. under occasional steering. The formulation was then placed into the resin tray of a dual-wavelength DLP 3D printer, with wavelengths of 365 nm and 450 nm respectively. The 3-dimensional object was computer designed and converted into an STL file suitable for 3D printing with two materials. The main body of the object was designed to be 3D printed with insoluble materials, whereas the supports were designed to be built with soluble material.

The object was built in a layer-by-layer fashion, using a bottom-up 3D printing process, in which object areas that are meant to be soluble were illuminated with a wavelength of 450 nm, whereas insoluble areas were illuminated with 365 nm. Upon completion of the 3D printing process, the part was initially immersed for 5 minutes in isopropanol to remove excess resin. Then, the support structures were dissolved by immersing the green ceramic body in a warm (80° C.) sodium hydroxide solution (pH=8).

After completing the dissolution of the supports, the part was post-cured at 80° C. for 12 hours, then placed into a debinding oven for 24 hours, before being moved into a sintering furnace for additional 12 hours to give a dense silica part. A similar process has been performed with alumina-filled materials.

### Example 5: Multi-Material 3D Printing with Partially Soluble Supports

50 g of 3-ethyloxetane-3-methanol (UviCure S130, Lambson Ltd.) were combined with 50 g of bis((3,4-epoxycyclohexyl)methyl) adipate (UviCure S128, Lambson Ltd), 40 g of 4-acryloylmorpholine (ACMO, Rahn AG, Switzerland), 5 g of 3-sulfopropylacrylate potassium salt (Sigma Aldrich), 5 g of Polyvinylpyrrolidone (PVP K30, TCI Chemicals Mw=40,000), 8 grams of (sulfanediyldibenzene-4,1diyl)bis(diphenylsulfonium) bis(hexafluoro antimonate) (SpeedCure S976S, Lambson Ltd.), 500 mg of 1-chloro-4-propoxythioxanthone (SpeedCure CPTX, Lambson Ltd) and 500 mg of phenylbis(2,4,6-trimethylbenzoyl) phosphine oxide (SpeedCure BPO, Lambson Ltd) in a dark vessel. The reaction mixture was mixed for 120 minutes at 50° C. until the visible dissolution of all solids. The formulation was then placed into the resin tray of a dual-wavelength DLP 3D printer, with wavelengths of 365 nm and 450 nm, respectively. The 3-dimensional object was computer designed and converted into an STL file suitable for 3D printing with two materials. The object was designed to have a rigid main body and rigid supports from the same material, while the supports are connected to the main body using a soluble material. The connection points were designed to be 1.5 centimeters in length and 0.25 centimeters in diameter. The object was built in a layer-by-layer fashion, using a bottom-up 3D printing process, in which object areas that are meant to be soluble were illuminated with a wavelength of 450 nm, whereas insoluble areas of the object were illuminated with 365 nm. Upon completion of the 3D printing process, the part was initially immersed for 5 minutes in isopropanol to remove excess resin. The support removal process was performed by immersing the 3D printed part into a wash unit containing tap water (pH=7) for 20 minutes at 80° C., to yield a clean, support-free 3D printed object, and the support structures separately. Subsequently, the support structures were disposed of, and the 3D printed part was rinsed with cold water and isopropanol, then post-cured under UV at 60° C. for 2 hours.

### Example 6: Multi-Material 3D Printing of Multi-Colored Objects: Method 1

40 g of 2 hydroxyethyl acrylate (HEA, BASF GmbH), 10 g of polyethylene glycol diacrylate (Ebecryl 11, Allnex Resins UK, Ltd.), and 50 grammes of 3,4-epoxycyclohexylmethyl 3,4-epoxycyclohexanecarboxylate (UviCure S105, Lambson Ltd), 10 g of 1,4 bis(2,3-epoxyporpoxy)anthraquinone (epoxidized quinizarin, prepared using the method published by D.-L. Versace et al. Macromolecules 2020), 4 g of (sulfanediyldibenzene-4,1diyl)bis(diphenylsulfonium) bis(hexafluoroantimonate) (SpeedCure 976S, Lambson Ltd.), 200 mg of 1-chloro-4-propoxythioxanthone (SpeedCure CPTX, Lambson Ltd) and 500 mg of phenylbis(2,4,6-trimethylbenzoyl)phosphine oxide (SpeedCure BPO, Lambson Ltd) were combined in a dark vessel. The reaction mixture was mixed for 120 minutes at 50° C. until the visible dissolution of all solids. The formulation was then placed into the resin tray of a dual-wavelength DLP 3D printer, with wavelengths of 365 nm and 450 nm, respectively. The 3-dimensional object was computer designed and converted into an STL file suitable for 3D printing with two materials. The object was designed to display translucent, colorless areas and yellow-orange areas. The colorless areas were illuminated with a wavelength of 450 nm, whereas the colored areas of the object were illuminated with 365 nm. The object was built in a layer-by-layer fashion, using a bottom-up 3D printing process. Upon completion of the 3D printing process, the 3D printed part was initially immersed for 5 minutes in isopropanol to remove excess resin, then placed for 30 minutes in a methanol bath at room temperature, followed by a 15 minutes wash in an isopropanol bath. Subsequently, the 3D printed part was post-cured for two hours at 60° C. under UV to yield a multi-colored 3D printed object.

### Example 7: Multi-Material 3D Printing of Multi-Colored Objects: Method 2

70 g of urethane diemthacrylate (UDMA, Visiomer HEMATMDI, Evonik AG) and 30 g of Triethylene glycol dimethacrylate (Bisomer TEGDMA, Geo Speciality Chemicals Inc.) were combined in a dark container with 500 mg of phenylbis(2,4,6-trimethylbenzoyl)phosphine oxide (SpeedCure BPO, Lambson Ltd.) and stirred for 30 minutes at 50° C. until the visible dissolution of all solids. Then, a mixture of 50 mg of the blue photochromic dye DAE-001 (Yamada Chemicals Co, Ltd.), 50 mg of the red photochromic dye DAE-0018 (Yamada Chemicals Co, Ltd) and 300 mg of the yellow photochromic dye DAE-0068 (Yamada Chemicals Co, Ltd.) were added to the monomer mixture and the reaction mixture was stirred for 180 minutes at 50° C. to yield a dark brown solution. The formulation was then placed into the resin tray of a DLP 3D printer, with a wavelength of 450 nm. The 3-dimensional object was computer designed and converted into an STL file suitable for 3D printing. The object was built in a layer-by-layer fashion, using a bottom-up 3D printing process. Upon completion of the 3D printing process, the 3D printed part was initially immersed for 15 minutes in isopropanol to remove excess resin, then post-cured for two hours under UV light (385 nm) to yield a brown part. Subsequently, certain segments of the part were selectively illuminated with different wavelengths: certain segments were illuminated with red light emitted by a LED array (630 nm) for 600 seconds, while the rest of the part was covered, yielding red segments in the part. Other segments were illuminated with green light emitted by a LED array (530 nm) for 60 seconds, while the rest of the part was covered yielding green segments. Other areas were illuminated with blue light from a LED array (460 nm) for 60 seconds, while the rest of the part was covered with a dark cloth, yielding dark blue segments. The finished object displayed red, green, and dark blue areas.

### Example 8: Multi-Material 3D Printing of Multi-Colored Objects: Method 3

40 g of 2-hydroxyethyl acrylate (HEA, BASF GmbH), 10 g of polyethylene glycol diacrylate (Ebecryl 11, Allnex Resins UK, Ltd.), and 50 g of 3,4-epoxycyclohexylmethyl 3,4-epoxycyclohexanecarboxylate (UviCure S105, Lambson Ltd), 4 g of (sulfanediyldibenzene-4,1diyl)bis(diphenylsulfonium) bis(hexafluoroantimonate) (SpeedCure 976s, Lambson Ltd.), 200 mg of 1-chloro-4-propoxythioxanthone (SpeedCure CPTX, Lambson Ltd.) and 500 mg of phenylbis(2,4,6-trimethylbenzoyl)phosphine oxide (SpeedCure BPO, Lambson Ltd.) were combined in a dark vessel. The reaction mixture was mixed for 120 minutes at 50° C. until the visible dissolution of all solids. Then, a mixture of 50 mg of the blue photochromic dye DAE-001 (Yamada Chemicals Co, Ltd), 50 mg of the red photochromic dye DAE-0018 (Yamada Chemicals Co, Ltd.) and 300 mg of the yellow photochromic dye DAE-0068 (Yamada Chemicals Co, Ltd.) was added to the monomer mixture and the reaction mixture was stirred for 180 minutes at 50° C. to yield a dark brown solution.

The formulation was then placed into the resin tray of a dual-wavelength DLP 3D printer, with wavelengths of 365 nm and 450 nm, respectively. The 3-dimensional object was computer designed and converted into an STL file suitable for 3D printing with two materials. The object was designed to display soft elastomeric areas and rigid segments. The soft elastomeric areas were illuminated with a wavelength of 450 nm, whereas the rigid areas of the object were illuminated with 365 nm. The object was built in a layer-by-layer fashion, using a bottom-up 3D printing process. Upon completion of the 3D printing process, the 3D printed part was initially immersed for 5 minutes in isopropanol to remove excess resin, then placed for 30 minutes in a methanol bath at room temperature, followed by a 15 minutes wash in an isopropanol bath. Then post cured for two hours under UV light (385 nm) to yield a brown part.

Subsequently, certain segments of the part were selectively illuminated with different wavelengths: soft segments were illuminated with red light emitted by a LED array (630 nm) for 120 seconds, while the rest of the part was covered, yielding soft red segments in the part. Rigid segments were illuminated with blue light from a LED array (460 nm) for 60 seconds while the rest of the part was covered, yielding dark blue segments. The finished object displayed soft red and rigid dark blue segments.

1-51. (canceled)

52. A process for forming a 3D object having a plurality of material regions, one or more of the plurality of material regions is soluble in a fluid not capable of solubilizing another of said plurality of material regions, the process comprising
irradiating with a multi-wavelength light source, or a plurality of light sources for generating radiation of different wavelengths, a resin comprising two or more different types of polymerizable materials and two or more different types of light-sensitive materials,
at least two of said two or more light-sensitive materials are selected amongst radical and ionic initiators,
wherein each of the two or more different types of polymerizable materials is polymerized into a different polymeric material by a different initiator of the at least two initiators in response to irradiation by light generated from the light source, said light being of a predetermined wavelength,
wherein one or more of the two or more different types of polymerizable materials is polymerized into one or more soluble polymeric materials that are each fully or partially soluble in the fluid not present in the resin and in which each of the other polymeric materials are insoluble, thereby forming the object.

53. The process according to claim 52, the process comprises irradiating with a multi-wavelength light source, or a plurality of light sources a resin comprising two or more or a plurality of polymerizable materials and a plurality of corresponding radical and/or ionic initiators, wherein each of the plurality of different types of polymerizable materials is polymerized by a different initiator of the plurality of corresponding radical and/or ionic initiators into a different polymeric material, wherein one or more of the plurality of different types of polymerizable materials is polymerized into one or more soluble polymeric materials that are each fully soluble in the fluid not present in the resin and in which each of the other polymeric materials are insoluble, thereby forming the object.

54. A vat photopolymerization process, the process comprising:
irradiating a resin comprising two or more different types of polymerizable materials and two or more different types of light-sensitive materials,
at least two of said two or more light-sensitive materials are selected from radical and ionic initiators, wherein each of the two or more different types of polymerizable materials is polymerized into a different polymeric material by a different initiator of the at least two initiators,
wherein one or more of the two or more different types of polymerizable materials is polymerized into one or more soluble polymeric materials that are each partially or fully soluble in a fluid selected from a solvent and a solution, said fluid not present in the resin and in which each of the other polymeric materials are insoluble;
wherein said irradiating comprising directing a multi-wavelength device or a plurality of light sources generating radiation of different wavelengths in a direction of the resin to initiate or induce selective polymerization of each of the two or more different types of polymerizable materials in different regions of the resin to yield the 3D object; and
treating the object in the fluid to cause dissolution of the one or more soluble polymeric materials in the solvent or the solution, maintaining intact each of the other polymeric materials present in the object.

55. The process according to claim 52, wherein the multi-wavelength device comprises a dual-wavelength digital light processing (DLP) projector, or two DLP projectors of which one displays a UV irradiation wavelength and a second displays visible light or NIR irradiation.

56. The process according to claim 52, wherein the light-sensitive material comprises an initiator and at least one material capable of changing its color upon irradiation.

57. The process according to claim 56, wherein the change in color involves transformation from a colorless material to a colored material.

58. The process according to claim 57, wherein the material capable of changing its color upon light irradiation is a light-sensitive pigment or dye.

59. The process according to claim 52, wherein the resin comprises a polymerizable material and at least one light-sensitive material that is not polymerizable.

60. The process according to claim 59, wherein at least one of the polymerizable materials is a polymerizable material that changes its color upon polymerization.

61. The process according to claim 52, wherein the fluid is an organic solvent or an aqueous solution.

62. The process according to claim 52, wherein the polymerizable material comprises or consists of monomers capable of undergoing thermal free radical polymerization or radical photopolymerization or thermal latent cationic polymerization or cationic photopolymerization, or anionic photopolymerization.

63. The process according to claim 52, wherein the resin comprises
a monomer that polymerizes upon reaction with a radical initiator to form a water-soluble polymer; and
an epoxy or oxetane monomer mixture and a filler, wherein the epoxy or oxetane monomer polymerizes in presence of a cationic initiator to provide a polymer-filler composite material that is not soluble in water.

64. The process according to claim 63, wherein the filler is selected from a ceramic filler, sand, and a metal filler.

65. The process according to claim 64, for manufacturing an object comprising a polymer-filler composite.

66. The process according to claim 65, wherein the polymer in the polymer-filler composite is partially or fully soluble or decomposable in the fluid.

67. The process according to claim 65, the process comprising a step of treating the object in a fluid selected to solubilize or decompose the polymer in the composite.

68. The process according to claim 52 for manufacturing a multicolored object, having two or more regions of different colors, color tones, or hues.

69. A vat photopolymerization process for forming a multicolored 3D object, the process comprising irradiating with a multi-wavelength light source, or a plurality of light sources, generating radiation of different wavelengths, a resin comprising one or more different types of polymerizable materials, one or more radical and/or ionic initiators and one or more light-sensitive pigments or dyes, wherein each of the different types of polymerizable materials is polymerized into a different polymeric material by a different initiator in response to irradiation by light generated from the light source, said light being of a predetermined wavelength, and wherein at least one of the light-sensitive pigments or dyes is photoactivated to undergo a color change in response to light generated from the light source and having a wavelength that is different from the predetermined wavelength.

70. The process according to claim 69, wherein the light-sensitive pigment or dye is selected amongst photochromic, photoreactive or photochangable pigments or dyes.

71. The vat photopolymerization process according to claim 18,
the process comprising obtaining a resin comprising two or more different types of polymerizable materials and two or more different types of light-sensitive materials, at least two of said two or more light-sensitive materials are selected from radical and ionic initiators, wherein each of the two or more different types of polymerizable materials is polymerizable selectively by (only) one of the at least two initiators into a polymeric material,
provided that one or more of the two or more different types of polymerizable materials is configured to polymerize into one or more soluble polymeric materials partially or fully soluble in a pre-selected fluid, said pre-selected fluid not present in the resin and is one in which each of the other polymeric materials are insoluble;
irradiating the resin by light comprising a plurality of distinct wavelengths generated by a multi-wavelength device or a plurality of light sources to initiate or induce selective polymerization of each of the two or more different types of polymerizable materials in different regions of the resin to yield the 3D object; and treating the object in or contacting the object with the fluid to cause dissolution or decomposition or disintegration of the one or more soluble polymeric materials in the fluid, maintaining intact each of the other polymeric materials present in the object.
